(19) United States
(12) Patent Application Publication
(10) Pub. No.: US 2026/0347709 A1
(43) Pub. Date: Nov. 5, 2026

(54) SYSTEM AND METHOD TO STABILIZE CRUDE OIL

(71) Applicant: OCCIDENTAL OIL AND GAS CORPORATION, Houston, TX (US)

(72) Inventors: Andres S. LOPEZ, Katy, TX (US); Byron GRIFFIN, Houston, TX (US)

(21) Appl. No.: 19/118,814

(22) PCT Filed: Oct. 9, 2023
(86) PCT No.: PCT/US2023/076374

§ 371 Date: Apr. 7, 2025

Related U.S. Application Data
(60) Provisional application No. 63/414,273, filed on Oct. 7, 2022.

(51) Int. Cl. C10G 53/04

(52) U.S. Cl. CPC C10G 53/04; C10G 2300/1033; C10G 2300/4006; C10G 2300/4012

(57) ABSTRACT

A process for stabilizing an oil field production stream, the process comprising (i) providing a liquid hydrocarbon stream, where the liquid hydrocarbon stream includes volatiles; (ii) removing a portion of the volatiles from the liquid hydrocarbon stream to thereby form a modified liquid hydrocarbon stream; (iii) introducing a gaseous hydrocarbon to the liquid hydrocarbon stream to form a mixture including liquid hydrocarbons, volatiles, and introduced gaseous hydrocarbons; and (iv) separating at least a portion of the volatiles and introduced gaseous hydrocarbons from the mixture to thereby form a stabilized liquid hydrocarbon stream.

### FIELD OF THE INVENTION

Embodiments of the invention are directed toward a system and method for stabilizing crude oil. In particular, embodiments are directed toward systems and methods that employ hydrocarbon gases (e.g. methane) as a stripping gas to reduce the volatility of produced oil.

### BACKGROUND OF THE INVENTION

The volatility of crude oil (i.e. the amount of volatile compounds within crude oil) is measured by the Reid Vapor Pressure (RPV) and is desirably low (e.g. below about 9 psi) for several reasons including environmental and safety reasons. For example, volatiles can be emitted from storage tanks, and therefore the Environmental Protection Agency regulates these emissions under the New Source Performance Standards. Oil produced from unconventional wells, which are wells within relatively non-porous formations such as shale, has been generally found to have higher RPV.

Current technology includes the use of vapor recovery units (VRUs), which are generally capture systems that communicate with and capture emissions from tanks within a tank farm. The VRUs can collect the volatiles, which may also be referred to as a gasses, and compress them for subsequent storage, transportation and use. Other known technologies include vapor recovery towers (VRTs), which are generally tall pressure vessels that are positioned between separators and tank storage or the point of sale. These vessels use at least one of time, temperature, and pressure to remove volatiles from the crude oil. Gases collected from the VRTs are typically delivered to a VRU for subsequent pressurization and transportation.

For example, a conventional oil stabilization system is shown in FIG. 1, which shows system 11 including a separator 13, a line heater 15, a vapor recovery tower 17, an a vapor recovery unit 19. Separator 13 receives an inlet stream via conduit 12. Separator, which is adapted to separate gas and liquids, directs a gaseous stream via conduit 14, a water stream via conduit 16, and an oil stream via conduit 18. The oil stream within conduit 18 undergoes a pressure drop a valve 21, and is heated at line heater 15. Temperature and pressure within line heater 15 release volatiles from the oil, which volatiles are directed toward vapor recover unit 19 via conduit 18. The heated oil is then directed toward vapor recovery tower 17 via conduit 20. The oil stream passes through valve 23 and pressure and temperature within vapor recovery tower 17 cause further separation of volatiles from the oil. These volatiles are directed toward vapor recovery unit 19 via conduit 22. Oil is recovered from vapor recovery tower 17 via conduit 24.

### SUMMARY OF THE INVENTION

One or more embodiments of the invention provide a process for stabilizing an oil field production stream, the process comprising (i) providing a liquid hydrocarbon stream, where the liquid hydrocarbon stream includes volatiles; (ii) removing a portion of the volatiles from the liquid hydrocarbon stream to thereby form a modified liquid hydrocarbon stream; (iii) introducing a gaseous hydrocarbon to the liquid hydrocarbon stream to form a mixture including liquid hydrocarbons, volatiles, and introduced gaseous hydrocarbons; and (iv) separating at least a portion of the volatiles and introduced gaseous hydrocarbons from the mixture to thereby form a stabilized liquid hydrocarbon stream.

Other embodiments of the invention provide a process for stabilizing an oil field production stream, the process comprising (i) providing a production stream including oil, hydrocarbon gas, and optionally water; (ii) separating at least a portion of the hydrocarbon gas from the production stream within a first separator to thereby form a gaseous stream and a liquid hydrocarbon stream, where the liquid hydrocarbon stream includes volatiles contained therein; (iii) separating a portion of the volatiles contained within the liquid hydrocarbon stream within a second separator to thereby form a modified liquid hydrocarbon stream; (iv) dispersing at least a portion of the gaseous stream into the modified liquid hydrocarbon stream to form a mixture; and (v) further separating the hydrocarbon gas from the mixture within a third separator.

### BRIEF DESCRIPTION OF THE DRAWINGS

FIG. 1 is a schematic diagram of an oil stabilization system according to the prior art.

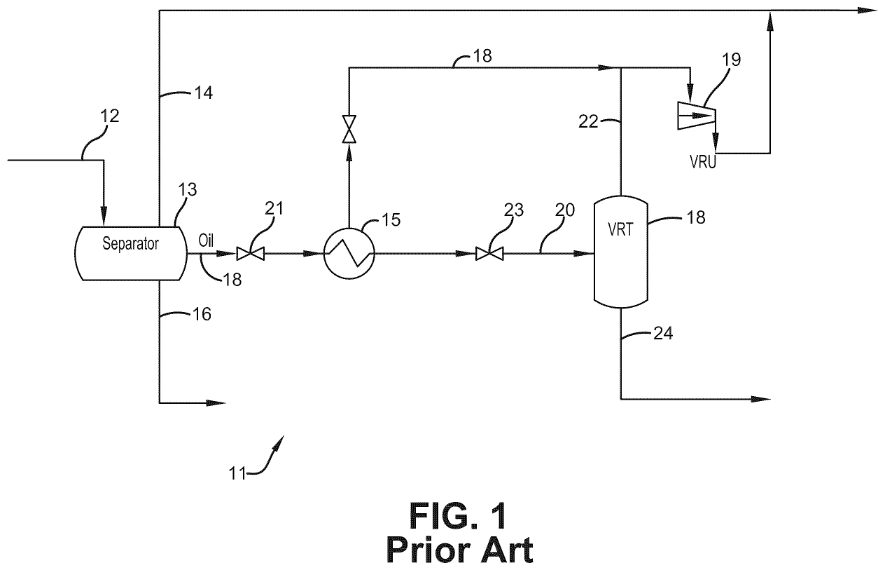

FIG. 2 is a schematic diagram of an oil stabilization system according to embodiments of the present invention.

FIG. 3 is a side schematic view of an inlet conduit to a vapor recovery tower according to embodiments of the invention.

FIG. 4 is a schematic diagram of an oil stabilization system according to embodiments of the present invention.

### DETAILED DESCRIPTION OF ILLUSTRATIVE EMBODIMENTS

Embodiments of the invention are based, at least in part, on the discovery of a system and process to stabilize crude oil; i.e. a system and process to reduce the Reid Vapor Pressure (RVP) of crude oil. According to embodiments of the invention, a hydrocarbon gas stream, such as a methane-containing stream, is employed as a stripping gas to further stabilize a liquid hydrocarbon stream (e.g. an oil stream). In one or more particular embodiments, a crude oil production stream undergoes phase separation to produce a liquid hydrocarbon stream and a gas stream. At least a portion of the liquid hydrocarbon stream, which includes crude oil, is routed to a downstream separator, such as a vapor recovery tower (VRT), for further reduction of volatiles. At least a portion of the gas stream is reintroduced to the hydrocarbon liquid stream as a stripping gas, which serves to enhance the stabilization of the oil by enhancing volatile separation within the downstream separator. It has been discovered that oil stabilization, such as takes place in the prior art within VRTs, results in inefficient carbon recovery since conventional VRTs, while reducing volatiles, also generate carbon dioxide in the generation of heat or pressure to drive the separation of volatiles from the liquid hydrocarbons. Embodiments of the invention advantageously achieve crude oil stabilization and achieve a net reduction in carbon emissions because the use of recovered hydrocarbon gases (e.g. methane) as a stripping gas allows for oil stabilization with reduced or completely eliminated energy inputs to downstream separators such as VRTs (e.g. without pre-heating the crude oil before separation).

### Oil Production System

Those skilled in the art appreciate that the oil stabilization system of the present invention is one component of an overall oil production system that may include an oil field, a satellite separation facility, an optional downstream gas plant, and optional oil storage tanks. The various constituents of the oil production system that work in conjunction with the oil stabilization system of this invention may be conventional in nature. In particular embodiments, the systems and processes of this invention operate in conjunction with unconventional oil fields, which include those oil fields wherein one or more of the wells are drilled within non-porous formations such as those formations that have a permeability below 0.1 millidarcies.

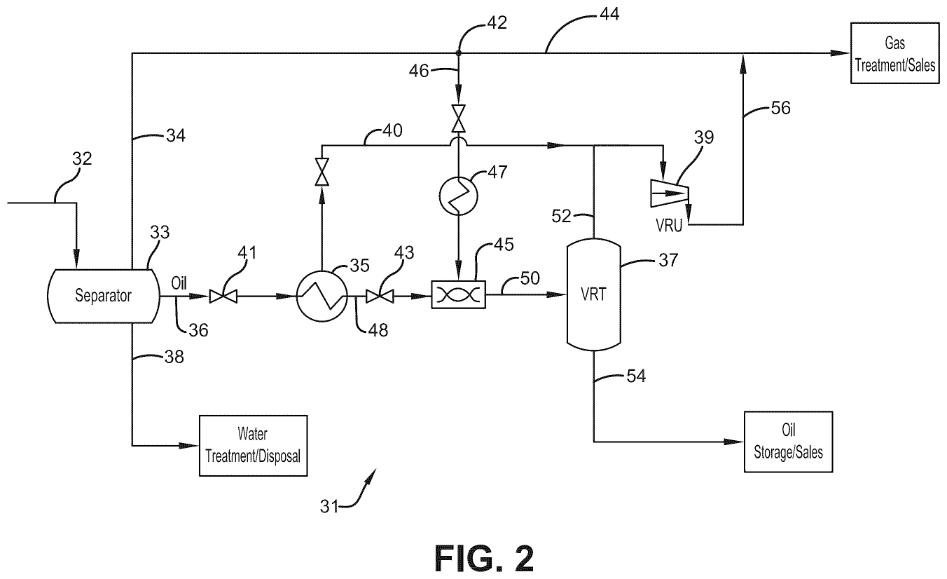

Aspects of the present invention can be described with reference to FIG. 2, which shows oil stabilization system 31 including a separator 33, an optional line heater 35, a vapor recovery tower 37, which may also be referred to as VRT 37, and a vapor recovery unit 39, which may also be referred to as VRU 39. System 31 also includes an in-line mixer 45.

During operation, separator 33 receives an inlet stream, which may also be referred to as crude oil stream, via conduit 32. As will be explained in greater detail below, and as understood by the skilled person, the inlet stream may derive from upstream satellite separation facilities operating in conjunction with an oil field. In one or more embodiments, separator 33 is adapted to separate the inlet stream into a gaseous stream, a hydrocarbon liquid stream, and a water stream. For example, separator 33 may include a three-phase separator that separates the inlet stream carried by conduit 33 into a gaseous stream that is carried away from separator 33 via conduit 34, a liquid hydrocarbon stream that is carried away via conduit 36, and an aqueous stream, which may also be referred to as water stream, that is carried away via conduit 38. The skilled person will appreciate that, in the alternative, separator 33 may include multiple separators arranged in parallel or in series. Also, these multiple separators can include two-phase or three-phase separators or combinations thereof.

The aqueous stream, which is carried by conduit 38, can be directed to an injection well (not shown). The skilled person will appreciate that the aqueous stream can undergo additional separations or purifications to remove hydrocarbon liquids dissolved or otherwise entrained in the aqueous stream, or to otherwise treat the stream prior to disposal or further use. For example, the aqueous stream can be treated within a hydrocyclone unit to produce a liquid hydrocarbon stream and a purified aqueous stream. Using conventional techniques, the purified aqueous stream can be routed to underground injection and the recovered liquid hydrocarbons can be routed to market.

The liquid hydrocarbon stream, which may be referred to as an oil production stream, and which is carried by conduit 36, can be routed to an optional line heater 35. Using conventional techniques, the liquid hydrocarbon stream can be passed through valve 41 and undergo a pressure drop within line heater 35. Temperature and pressure within line heater 35 cause at least a portion of the volatiles entrained within the liquid hydrocarbon stream to be released. As shown, line heater 35 is in fluid communication with conduit 40, which directs volatiles to VRU 39. The liquid hydrocarbon stream, which may be referred to as a modified liquid hydrocarbon stream (due to loss of volatiles), is then routed, via conduit 48, to in-line mixer 45. It should be appreciated that a heater treater, which is a conventional device known to those skilled in the art, may be employed in addition to or in lieu of line heater 35. In yet other embodiments, an in-line separation vessel, such as a two-phase separator, which may operate in the absence of an added heat source, may be used in addition to or in lieu of line heater 35. In other words, the skilled person will appreciate that multiple arrangements and devices can be employed with the goal of changing the composition of the liquid hydrocarbon stream by removing a portion of the volatiles entrained therein prior to delivering the liquid hydrocarbon stream to further downstream separations, the latter of which will be described in greater detail below. Since line heater 35 can be substituted with a heater treater or simply a separation tank, reference may be made to a vessel 35 to refer to any of the possible devices, either alone or in combination.

The gaseous stream carried by conduit 34, which may also be referred to a produced gas stream, is routed to a splitter 42. Splitter 42 divides the gaseous stream into a primary gas stream, which is carried by conduit 44, and a sparge gas stream, which is carried by conduit 46. Primary gas stream can be handled in a conventional manner. For example, it can be routed to a gas plant (not shown) where it may undergo further purifications and appropriate pressurization and transported to market. For example, the primary gas stream can be pressurized and routed to a pipeline.

The sparge gas stream, which may also be referred to as stripping gas stream, is routed to in-line mixer 45 via conduit 46. The sparge gas stream may optionally be heated within heater 47, which may include an electric heater or other conventional in-line heater.

As provided above, the modified liquid hydrocarbon stream and the sparge gas stream are routed to in-line mixer 45 wherein the sparge gas stream is mixed into the liquid hydrocarbon stream. Stated differently, the liquid hydrocarbon stream receives the sparge gas stream within in-line mixer 45. The resulting mixture is routed, via conduit 50, to VRT 37. The skilled person will appreciate the degree of interaction between the sparge gas and the liquid hydrocarbon stream can be controlled by several variables including, but not limited to, the distribution mechanism associated with in-line mixer 35, the size of in-line mixer 35, and the length of conduit 50, which, together with flow rate, provides for a contact time (which may also be referred to as residence time) prior to entry into VRT 37. The skilled person can therefore, without undue experimentation or calculation, arrange the system in a manner to provide for a desired interaction and/or residence time between sparge gas and liquid hydrocarbon stream prior to entry into VRT 37.

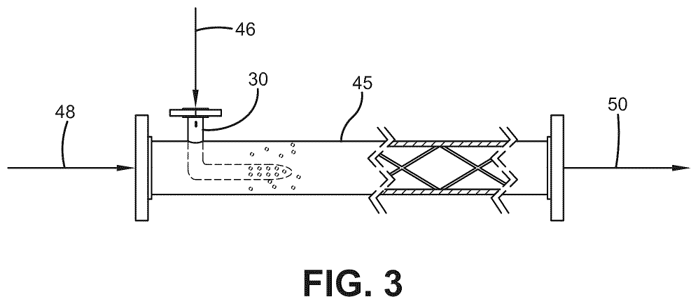

In one or more embodiments, the sparge gas is introduced to the liquid hydrocarbon stream, either directly within in-line mixer 45, or upstream of in-line mixer 45 by using an in-line distribution device. An example of an in-line distribution device is shown with reference to FIG. 3, which show in-line mixer 45, which receives modified liquid hydrocarbon stream via conduit 48 and a sparge gas stream via conduit 46. The sparge gas stream is distributed into the liquid hydrocarbon stream via distribution device 30. Distribution device 30 may be conventional in nature and may include, for example, an in-line sparger. The mixture of sparge gas and liquid hydrocarbon may undergo further static or dynamic mixing within in-line mixer 45, and then the mixture is ultimately directed toward VRT 37 via conduit 50.

VRT 37 may be conventional in nature and is generally adapted to separate the liquid hydrocarbon stream (i.e. the mixture of the modified liquid hydrocarbon stream and the sparge gas stream) into an overhead gaseous stream and a stabilized liquid hydrocarbon stream. In other words, conditions, such as temperature and pressure, within VRT 37 cause volatiles within the liquid hydrocarbons to separate from the liquid hydrocarbon. According to aspects of the present invention, the amount of volatiles (as measured by Reid Vapor Pressure described further below) within the liquid hydrocarbon is less than that of the modified liquid hydrocarbon stream, which was carried from vessel 35 via conduit 48, by having undergone further separation in the presence of the sparge gas.

The skilled person will appreciate that VRT 41 will include a volume of liquid (i.e. the liquid hydrocarbon) and a gaseous headspace, which is includes volatiles that separate from the mixture, and a liquid line separating the two phases. In one or more embodiments, the inlet of the mixture into VRT 37 may be disposed at or above the liquid line. The gaseous headspace within VRT 37 is in fluid communication with conduit 52, which routes the volatiles to VRU 39. The liquid level within VRT 37 is in fluid communication with conduit 54, which routes the liquid hydrocarbons downstream to, for example, storage and/or market and/or other use. The liquid hydrocarbon stream carried by conduit 54 may therefore also be referred to as a stabilized oil stream. The skilled person will also appreciate that downstream storage tanks may be in communication with a volatiles capture system, such as vapor recovery unit 39, that is adapted to receive and manage any volatiles captured from the stabilized oil stream.

VRU 39 may be conventional in nature and is adapted to receive and manage the gaseous streams directed to it. For example, VRU 39 can be adapted to compress the overhead gaseous stream and route the compressed gaseous stream, via conduit 56, downstream to a gas treatment plant and/or to market and/or to other uses. As shown, the gaseous stream within conduit 56 can optionally be merged with other gaseous streams within the system such as the primary gaseous stream carried by conduit 44. VRU 39 may also be adapted to compress a portion of the overhead gaseous stream to thereby provide a liquid hydrocarbon stream.

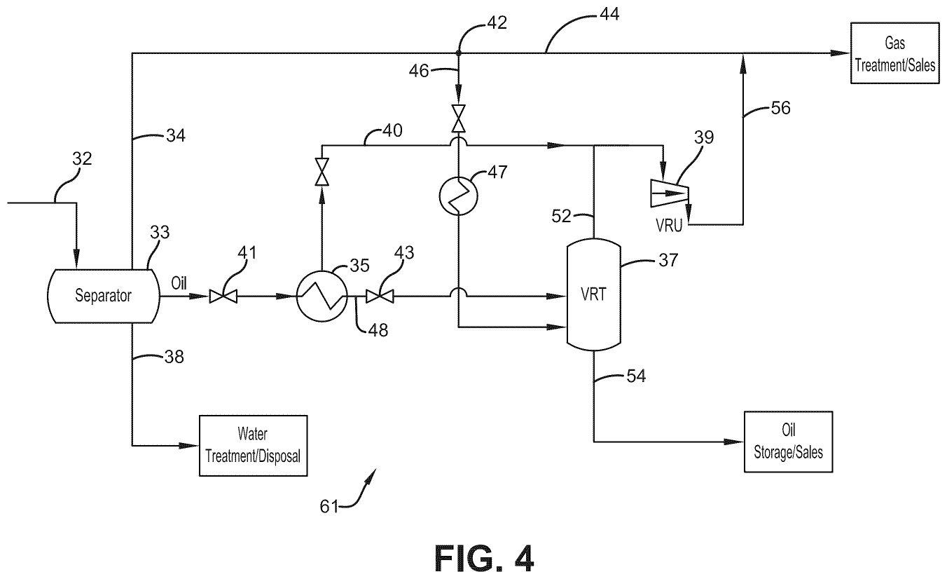

Another embodiment of the present invention can be described with reference to FIG. 4. In large part, the arrangement of the system of this embodiment, which includes system 61, is the same as the arrangement of system 31 described with reference to FIG. 2, and therefore the relevant description provided above relative to FIG. 2 is incorporated herein to this description. In this regard, it is particularly noted that system 61 does not include in-line mixer 45.

As shown in FIG. 4, system 61 generally includes separator 33, in-line mixer 35, VRT 37, and VRU 39. The water stream leaving separator 33 is routed to downstream processing or disposal. The liquid hydrocarbon stream leaving separator 33 is routed to downstream treatment (e.g. line heater) where it is compositionally changed by reducing the volatiles contained therein. The gaseous stream leaving separator 33 is split in a primary and a sparge gas stream, and the sparge gas stream is introduced back into liquid hydrocarbon stream (i.e. the modified liquid hydrocarbon stream).

In particular, the sparge gas stream, which is carried by conduit 46, and is optionally heated within line heater 47, is routed directly to VRT 37, where it is introduced to the liquid hydrocarbon stream, which is carried by conduit 48 and introduced to VRT 37 after passing through valve 43.

As described above, the volume of VRT 37 includes a liquid hydrocarbon bottoms, a gaseous headspace, and a liquid line separating the hydrocarbon liquid from the gaseous headspace. In one or more embodiments, the sparge gas stream is introduced into VRT 37 in the volume of liquid below the liquid line. In one or more embodiments, the sparge gas is introduced into VRT at or near the bottom of VRT 37.

In one or more embodiments, the sparge gas is introduced to the liquid hydrocarbon contained within VRT 37 using a distribution device (e.g. sparging device). Distribution devices are generally known in the art, and the skilled person can readily select an appropriate distribution device. As with the embodiments set forth with respect to FIG. 2, the skilled person will appreciate that the degree of interaction between the sparge gas and the liquid hydrocarbon stream can be controlled by several variables including, but not limited to, the distribution mechanism (i.e. sparging device) within VRT 37, the size of the gas bubbles produced thereby, and the dimensions of VRT 37, which, together with flow rate, provides for a contact time (which may also be referred to as residence time) as the sparge gas flows through the liquid hydrocarbon within VRT 37. The skilled person can therefore, without undue experimentation or calculation, arrange the system in a manner to provide for a desired interaction and/or residence time between sparge gas and liquid hydrocarbon stream within VRT 37. The skilled person will also appreciate that VRT 37 can be modified to promote mixing or distribution of the sparge gas as it flows through VRT 37 such as, by way of example, the inclusion of baffles or the like within VRT 37.

In yet other embodiments, the sparge gas stream is obtained from other sources besides being directly split off of the gaseous stream (i.e. from other sources than conduit 42). For example, a sparge gas stream, such as a methane stream, can be sourced from a gas conditioning facility, such as a natural gas conditioning facility, and fed to the processes of this invention. For example, and with reference to FIG. 2, an alternate source of hydrocarbon sparge gas (e.g. methane stream) can be obtained from alternative sources and introduced to the liquid hydrocarbon stream at or upstream of in-line mixer 45. And, with reference to FIG. 4, an alternate source of hydrocarbon sparge gas (e.g. methane stream) can be obtained from alternative sources and introduced to the liquid hydrocarbon stream within VRT 37.

### Characteristics of Inlet Stream

As explained above, the inlet stream may be received from a satellite separation facility that performed an initial separation on the oil production stream obtained from the oil wells. In other embodiments, the inlet stream is received directly from the oil wells. In either event, the inlet stream includes liquid hydrocarbons, gaseous hydrocarbons, optionally water, and optionally one or more constituents, such as carbon dioxide, that are typically found in production oil streams. Unless otherwise specified, reference to gas or liquid refers to the state of any particular substance at standard conditions of temperature and pressure.

In one or more embodiments, the gaseous stream leaving separator 33 is at a temperature of about 50 to 150 °F, and will generally include from about 73 to about 75 vol. % C1 hydrocarbon, from about 14 to about 15 vol. % C2 hydrocarbon, from about 6 to about 7 vol. % C3 hydrocarbon, from about 2 to about 3 vol. % C4 hydrocarbon, and from about 1 to about 2 vol. % nitrogen, with the balance including other volatiles, generally at less than 1 vol. % per species, which may include, for example, water, carbon dioxide, and other hydrocarbons. Where the sparge gas stream directly derives from the gaseous stream (i.e. it is split off as shown in FIG. 2), the sparge gas stream will, accordingly, include similar constituents. The skilled person appreciates that the constituents of the gaseous portion of an inlet stream may vary based upon several factors including, but not limited to, the geographical location of where the inlet stream is sourced. For example, the production streams from some locations may include a higher content of C1 hydrocarbon (i.e. a higher content of methane). The sparge gas stream, where taken as a split stream from a gaseous stream with higher C1 hydrocarbon content, will accordingly include higher C1 hydrocarbon content. In one or more embodiments, the sparge gas stream introduced to the liquid hydrocarbon stream in accordance with practice of this invention includes greater than 70 vol. %, in other embodiments greater than 75 vol. %, in other embodiments greater than 80 vol. %, in other embodiments greater than 85 vol. %, in other embodiments greater than 90 vol. %, and in other embodiments greater than 95 vol. % C1 hydrocarbons (e.g. methane).

### Operating Conditions

In one or more embodiments, separator 33 operates a pressure of greater than 30 psig, in other embodiments greater than 50 psig, in other embodiments greater than 75 psig, and in other embodiments greater than 100 psig. In these or other embodiments, inlet separator 33 operates a pressure of from about 30 to about 160 psig, in other embodiments from about 50 to about 150 psig, and in other embodiments from about 75 to about 140 psig.

In one or more embodiments, the temperature at which separator 33 operates is the temperature of the inlet stream into separator 33 because no additional heat is added to separator 33. In one or more embodiments, the temperature within separator 33 (i.e. the temperature of the input stream into separator 33) is greater than 50 °F, in other embodiments greater than 60 °F, and in other embodiments greater than 70 °F. In these or other embodiments, the temperature within separator 33 is less than 150 °F, in other embodiments less than 100 °F, and in other embodiments less than 90 °F. In one or more embodiments, the temperature within separator 33 is from about 50 to about 150 °F, in other embodiments from about 60 to about 100 °F, and in other embodiments from about 70 to about 90 °F.

As indicated above, the pressure of the liquid oil stream is let down prior to delivery to line heater 35 (i.e. vessel 35 as the case may be). In one or more embodiments, line heater 35 may operate a pressure of greater than 15 psig, and in other embodiments greater than 20 psig, and in other embodiments greater than 25 psig. In these or other embodiments, vessel 35 operates a pressure of from about 15 to about 50 psig, in other embodiments from about 20 to about 40 psig, and in other embodiments from about 25 to about 35 psig.

It is also discussed above that heating at line heater 35 is optional. The skilled person will appreciate that environmental conditions, as well as the nature and conditions of the inlet stream, can impact whether heating of the oil stream is necessary or desirable. In one or more embodiments, the temperature of the liquid hydrocarbon stream at vessel 35 may desirably be from about 100 to about 150 °F, in other embodiments from about 105 to about 140 °F, and in other embodiments from about 110 to about 130 °F.

In one or more embodiments, VRT 37 operates a pressure of less than 12 psig, in other embodiments less than 7 psig, and in other embodiments less than 5 psig. In these or other embodiments, VRT 37 operates a pressure of from about 1 to about 12 psig, in other embodiments from about 2 to about 7 psig, and in other embodiments from about 3 to about 5 psig.

As discussed above, one of the advantages of the present invention is the limited (or complete absence) of any energy, particularly heat energy, that is imparted on the liquid hydrocarbon stream carried from separator 33 to VRT 37. In one or more embodiments, the temperature of the liquid hydrocarbon stream entering VRT 37 is less than 100 °F, in other embodiments less than 95 °F, in other embodiments less than 90 °F, in other embodiments less than 85 °F, and in other embodiments less than 80 °F. In these or other embodiments, the temperature of the liquid hydrocarbon stream entering VRT 37 is greater than 50 °F, in other embodiments greater than 55 °F, in other embodiments greater than 60 °F, in other embodiments greater than 65 °F, and in other embodiments greater than 70 °F. In these or other embodiments, the temperature of the liquid hydrocarbon stream entering VRT 37 is from about 100 to about 50 °F, in other embodiments from about 95 to about 55 °F, in other embodiments from about 90 to about 60 °F, in other embodiments from about 85 to about 65 °F, and in other embodiments from about 80 to about 70 °F.

Similarly, in one or more embodiments, the temperature of the overhead gaseous stream exiting VRT 37 via conduit 52 is less than 100 °F, in other embodiments less than 95 °F, in other embodiments less than 90 °F, in other embodiments less than 85 °F, and in other embodiments less than 80 °F. In these or other embodiments, the temperature of the overhead gaseous stream exiting VRT 37 via conduit 52 is greater than 50 °F, in other embodiments greater than 55 °F, in other embodiments greater than 60 °F, in other embodiments greater than 65 °F, and in other embodiments greater than 70 °F. In these or other embodiments, the temperature of the gaseous stream exiting VRT 37 via conduit 52 is from about 100 to about 50 °F, in other embodiments from about 95 to about 55 °F, in other embodiments from about 90 to about 60 °F, in other embodiments from about 85 to about 65 °F, and in other embodiments from about 80 to about 70 °F.

As noted above, the presence of the sparge gas has been found to facilitate removal of volatiles entrained with the liquid hydrocarbon stream. The amount of sparge gas introduced to the liquid hydrocarbon stream can be quantified based upon the ratio of gas to oil, where gas is quantified in thousand standard cubic feet (MSCF) and the oil is quantified in barrels of oil (BO); i.e. MSCF/BO. In one or more embodiments, the ratio of gas introduced to the oil is from about 0.03/1 to about 1.17/1, in other embodiments from about 0.05/1 to about 1.5/1, or in other embodiments from about 0.07/1 to about 1.3/1 MSCF/BO.

As discussed above, the time that the sparge gas and modified liquid hydrocarbon contact each other can be manipulated to achieve a desired residence time. For example, it may desirable to arrange the system to achieve a residence time of greater than 30 seconds, in other embodiments greater than 60 seconds, and in other embodiments greater than 90 seconds. In these or other embodiments, it may be desirable to achieve a residence time of from about 30 seconds to about 3 minutes, or in other embodiments from about 60 seconds to about 2.5 minutes. It may also be desirable to control the size of the sparge gas bubbles being introduced into the liquid hydrocarbon (e.g. via distribution device associated with in-line mixer 45 or disposed within VRT 37). In one or more embodiments, a distribution device (e.g. sparger) is selected to achieve a gas bubble size having an average diameter of from about 30 to about 300 μm. The skilled person can also select a distribution device that can desirably disperse the sparge gas throughout the cross-section of the vessel (e.g. throughout the cross-section of in-line mixer 45 or VRT 37.

### Characteristics of Marketable Oil

As suggested above, practice of the present invention facilitates removal of volatile hydrocarbons dissolved or otherwise entrained in the crude oil. Notably, this reduction in volatile organic content (i.e. stabilization of the oil) is achieved at a net reduction in carbon emissions to the environment because the use of the sparge gas reduces or eliminates energy requirements that would otherwise be required to drive the separations taking place within VRT 37.

The oil that is ultimately produced by the invention, which can be delivered to market, advantageously has a relatively low RVP. In one or more embodiments, practice of the present invention provides an oil product having a Reid Vapor Pressure (RVP), as measured by ASTM D-323, of from about 3 to about 9, in other embodiments from about 5 to about 9, and in other embodiments from about 6 to about 8 psia. In these or other embodiments, practice of the present invention provides an oil product having an RVP of less than 10, in other embodiments less than 9, and in other embodiments less than 8 psia.

Various modifications and alterations that do not depart from the scope and spirit of this invention will become apparent to those skilled in the art. This invention is not to be duly limited to the illustrative embodiments set forth herein.

1. A process for stabilizing an oil field production stream, the process comprising:
(i) providing a liquid hydrocarbon stream, where the liquid hydrocarbon stream includes volatiles;
(ii) removing a portion of the volatiles from the liquid hydrocarbon stream to thereby form a modified liquid hydrocarbon stream;
(iii) introducing a gaseous hydrocarbon to the liquid hydrocarbon stream to form a mixture including liquid hydrocarbons, volatiles, and introduced gaseous hydrocarbons; and
(iv) separating at least a portion of the volatiles and introduced gaseous hydrocarbons from the mixture to thereby form a stabilized liquid hydrocarbon stream.

2. The process of claim 1, where said step of removing a portion of the volatiles from the liquid hydrocarbon stream takes place at a pressure of from about 15 to about 50 psig.

3. The process of claim 1, where said step of removing a portion of the volatiles from the liquid hydrocarbon stream takes place at a temperature of from about 100 to about 150 °F.

4. The process of claim 1, where said step of separating at least a portion of the volatiles and introduced gaseous hydrocarbons from the mixture takes place at a pressure of from about 1 to about 12 psig.

5. The process of claim 1, where said step of separating at least a portion of the volatiles and introduced gaseous hydrocarbons from the mixture includes forming an overhead stream of volatiles and introduced gaseous, and where the temperature of the overhead stream is less than 100 °F.

6. The process of claim 1, where said liquid hydrocarbon stream is provided by providing an oil production stream and separating the oil production stream into a gaseous stream and the liquid hydrocarbon stream.

7. The process of claim 6, where said providing an oil production stream and separating the oil production stream into a gaseous stream and the liquid hydrocarbon stream takes place at a pressure of from about 30 to about 160 psig.

8. The process of claim 7, where the gaseous stream from said step of separating the oil production stream is introduced to the liquid hydrocarbon stream in said step of introducing a gaseous hydrocarbon is to the liquid hydrocarbon stream to form a mixture including liquid hydrocarbons, volatiles, and introduced gaseous hydrocarbons.

9. The process of claim 1, where the modified liquid hydrocarbon stream includes less volatiles than the liquid hydrocarbon stream, and where the stabilized liquid hydrocarbon stream includes less volatiles than the modified liquid hydrocarbon stream.

10. The process of claim 1, where the stabilized liquid hydrocarbon stream is characterized by a Reid Vapor Pressure, as measured by ASTM D-323 of less than 10 psia.

11. A process for stabilizing an oil field production stream, the process comprising:
(i) providing a production stream including oil, hydrocarbon gas, and optionally water;
(ii) separating at least a portion of the hydrocarbon gas from the production stream within a first separator to thereby form a gaseous stream and a liquid hydrocarbon stream, where the liquid hydrocarbon stream includes volatiles contained therein;
(iii) separating a portion of the volatiles contained within the liquid hydrocarbon stream within a second separator to thereby form a modified liquid hydrocarbon stream;
(iv) dispersing at least a portion of the gaseous stream into the modified liquid hydrocarbon stream to form a mixture; and
(v) further separating the hydrocarbon gas from the mixture within a third separator.

12. The process of claim 11, where said step of further separating the hydrocarbon gas from the mixture takes place at a temperature of less than 100 °F.

13. The process of claim 11, where said step of further separating the hydrocarbon gas from the mixture takes place at a temperature of less than 95 °F.

14. The process of claim 11, where said step of further separating the hydrocarbon gas from the mixture takes place at a temperature of less than 90 °F.

15. The process of claim 11, where said third separator is a vapor recovery tower.

16. The process of claim 11, where said first separator is a three-phase separator.

17. The process of claim 11, where said step of separating at least a portion of the hydrocarbon gas from the production stream takes place at a temperature of from about 50 to about 150 °F and a pressure of from about 1 to about 12 psig.

18. The process of claim 11, where said step of dispersing at least a portion of the gaseous stream into the modified liquid hydrocarbon stream includes dispersing a gas to oil ratio of from 0.03/1 to 1.7/1 MSCF/BO.

19. (canceled)

20. The process of claim 11, where said step of dispersing at least a portion of the gaseous stream into the modified liquid hydrocarbon stream takes place upstream of the third separator.

21. The process of claim 11, where said step of dispersing at least a portion of the gaseous stream into the modified liquid hydrocarbon stream takes place within the second separator.
